(19) United States
(12) Patent Application Publication
(10) Pub. No.: US 2013/0218749 A1
(43) Pub. Date: Aug. 22, 2013

(54) METHOD AND SYSTEM FOR TRANSFER OF BULK COMMODITIES

(71) Applicant: Ganesh Mani, Pittsburgh, PA (US)

(72) Inventor: Ganesh Mani, Pittsburgh, PA (US)

(21) Appl. No.: 13/854,313

(22) Filed: Apr. 1, 2013

Related U.S. Application Data
(63) Continuation of application No. 09/648,855, filed on Aug. 25, 2000, now abandoned.
(60) Provisional application No. 60/150,906, filed on Aug. 26, 1999.

(51) Int. Cl. G06Q 40/04

(52) U.S. Cl. CPC G06Q 40/04
USPC 705/37

(57) ABSTRACT

A method and system are disclosed for making bulk groupings of various products and services available for purchase and sale by an individual or a business. The method includes grouping a plurality of commodities into a bulk bundle. A first price is then established for purchase of the entire bulk bundle. A second price can also be established to permit a consumer to obtain an option to purchase the bulk bundle at a future date. A suitable communication and transaction system, such as an Internet connection, can be used to establish a market in which the bulk bundles can be transferred between or among providers and consumers. The method and system therefore combine conventional trading elements with several new elements, including the concept of partial consumption, to provide a unique method that can be applied in a variety of product and service categories. The significant benefits of price discovery and automation of transactions associated with transfer of bulk bundle commodities are also provided to the consumer.

### CROSS REFERENCE TO RELATED APPLICATION

This application is a continuation of U.S. patent application Ser. No. 09/648,855, filed Aug. 25, 2000, entitled METHOD AND SYSTEM FOR TRANSFER OF BULK COMMODITIES, which application claims priority from U.S. Provisional Application Ser. No. 60/150,906, filed Aug. 26, 1999.

### FIELD OF THE INVENTION

The present invention generally relates to a method and system for marketing and distribution of commodity type items or options on such items. The present invention more particularly relates to a method and system for grouping a plurality of goods or services as commodity type items into a bulk bundle to sell the bundle or an option on the bundle to a consumer for at least partial consumption and/or subsequent transfer.

### BACKGROUND OF THE INVENTION

Particular goods and services, such as airline tickets, are regularly consumed by the public but have not been amenable to the role of conventional commodities. What is needed is a way to apply traditional capital market concepts such as trading commodities and purchasing options to provide an improved method for bundling and selling goods and services to a consumer.

It has been known to provide functionality such as web sites utilized on the Internet to offer items for sale and transfer those items between buyers and sellers. What is needed therefore is a method for combining the commodity and option aspects of traditional trading processes with Internet type technology to provide bulk bundled goods and services in the marketplace. What is also needed is a means to provide consumers with the benefit of price discovery or additional market knowledge when purchasing or selling commodity type items.

### DETAILED BRIEF DESCRIPTION OF THE DRAWINGS

A full understanding of the invention can be gained from the following description of the preferred embodiments when read in conjunction with the accompanying drawing in which:

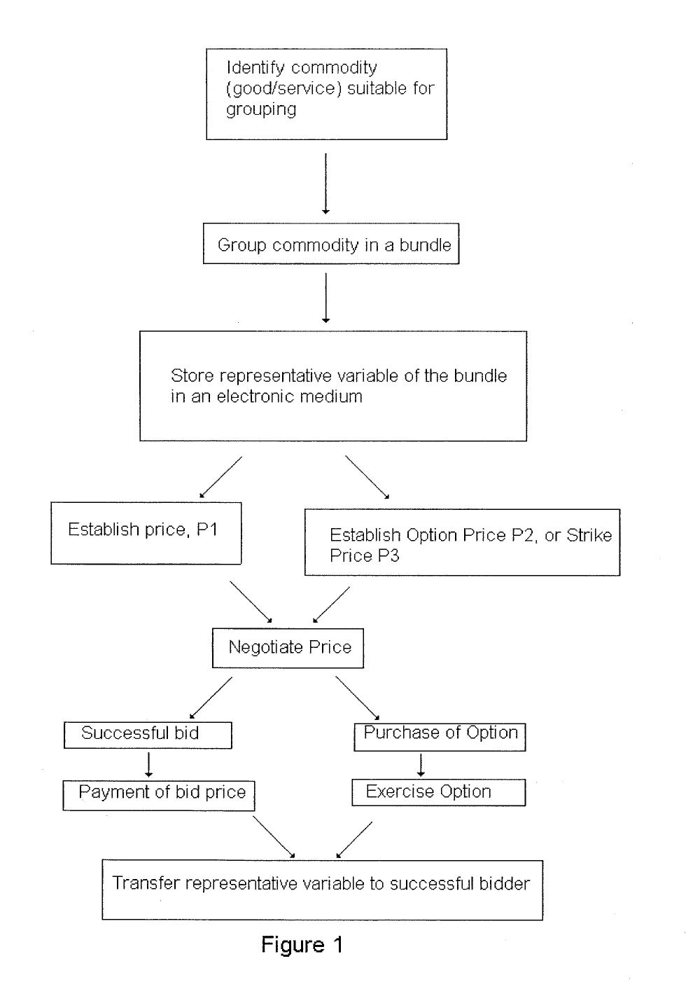

FIG. 1 is a flow chart that illustrates the steps carried out for transferring bulk commodities electronically.

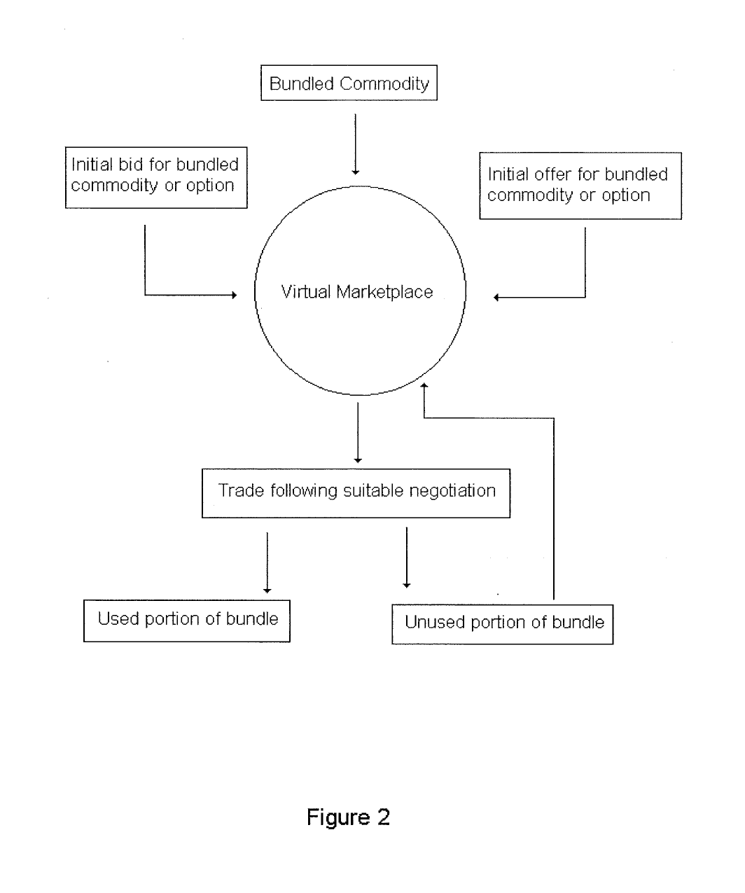

FIG. 2 is a flow chart that illustrates the transaction step and post transfer disposition of a partial bundle.

### SUMMARY OF THE INVENTION

An aspect of the present invention is to provide a computer implemented method for electronic marketing and distribution of commodities and/or options for commodities, which includes the steps of, identifying a commodity, grouping said commodity in a bundle, storing representative variables of said bundle of commodities in an electronic medium, and performing a transaction with an offer for sale, a bid, and a transfer of said representative variable.

Another aspect of the invention is to provide a computer readable medium containing instructions for performing a method for marketing and distribution of commodities and/or options for commodities which includes the steps of, identifying a commodity, grouping said commodity in a bundle, storing representative variables of said bundle of commodities in an electronic medium, and performing a transaction with an offer for sale, a bid, and a transfer of said representative variable.

A further aspect of the invention is to provide a computer system containing instructions for performing a method for marketing and distribution of commodities and/or options for commodities which includes the steps of, identifying a commodity, grouping said commodity in a bundle, storing representative variables of said bundle of commodities in an electronic medium, and performing a transaction with an offer for sale, a bid, and a transfer of said representative variable.

Another aspect of the invention is to provide a data transmission medium containing instructions for performing a method for marketing and distribution of commodities and/or options for commodities which includes the steps of identifying a commodity, grouping said commodity in a bundle, storing representative variables of said bundle of commodities in an electronic medium, and performing a transaction with an offer for sale, a bid, and a transfer of said representative variable.

### DETAILED DESCRIPTION

As used herein, the term “commodity” is used to indicate a good, a service, or a reasonable combination thereof As used herein, the terms “bundle” or “bundled” used without or in combination with “bulk” refer to a grouping of a plurality of commodities. As used herein, the term “segment” is used to refer to a unit portion of a grouping of a plurality of commodities.

The method of the present invention includes the step of identifying a suitable commodity which can be grouped into a bulk bundle. Specific examples of the types of goods and services which can be bundled are discussed hereinafter and include, but are not limited to, automobile rentals, hotel room rentals, airplane tickets, music and office supplies. In a preferred embodiment, the segments will be electronically stored in a suitable medium to enable subsequent transfers. For example, it will be understood that a purchaser can have an account associated with a web site with permits crediting and debiting of bulk bundles purchased on a medium such as the Internet. It will also be understood that a suitable commodity can be susceptible to presentment in a tangible format such as a coupon book or other similar physical segmentation.

Once a suitable commodity has been identified, a plurality of the commodity are grouped into a bulk bundled quantity, Q. A price P1 is then established for the bulk bundled quantity Q thereby establishing a price per unit value for the individual segments of the plurality of the commodity grouping. This price per unit value can be expressed as P1 divided by Q. In another step of the present method, an option price P2 can be established for the bulk bundle which can be used by a purchaser to obtain a right, and not an obligation, to purchase the given commodity at a future time at a price P3. While the option price P2 is generally less than the price P1, the option price P2 is determined by factors such as the time duration of the option before it expires, the historical volatility of the price of a given commodity, the availability of comparable options offered by different providers and other relevant factors.

A time period for exercising the option can also be specified as a condition of the sale of the bulk bundled commodity. This time period condition can be relatively short or relatively long based on the market price volatility of a given commodity. It will be understood that the bulk bundle price P1 and the bulk bundle option price P2 are established consistent with prevailing market conditions for the offered goods and services and will be subject to the respective financial objectives and positions of the buyer and seller.

In another step of the method of the present invention, prices may be set by the seller, in the form of an offer for sale, or by the buyer, in the form of an initial bid on a bundled commodity. A conventional auction protocol or one-to-one negotiation can also be employed to determine the final sale price. In addition, a buyer is able to bid for or negotiate an aggregate price for multiple offerings from the same seller potentially to obtain a volume discount. Also, a corporate or other relatively large and sophisticated seller can impose restrictions on the type of buyer eligible to purchase its bulk bundled commodity. For example, selling bundled products or services to a competitor may not be desirable given price comparison considerations. An age minimum, for example, can also be applied to certain items, such as car rental services, so that these commodities are not provided for sale to a class of consumers defined by an age characteristic.

It will be appreciated that after-purchase transfer of the commodities and the options for the commodities can also be permitted for a given bulk bundled quantity. Transfer of bulk bundled commodities is especially advantageous when applied to the cost reduction measures of a relatively large company. For example, a “blue chip” corporation can contract with a seller to buy 10,000 nights of hotel room rentals at a given hotel chain. Optionally, the corporation can have the flexibility to transfer the contract after using a quantity or percentage less than the total quantity included in its initial bulk bundle. This can be considered a partial consumption of the original bulk bundled commodity.

Thus, the method of the present invention provides a significant benefit in the form of a business-to-business operation mechanism for electronic purchase of staple items such as airline tickets and car and hotel room rentals. In one particular embodiment, airline tickets can be transferred as electronic tickets with the option of making a hardcopy available to accommodate special requests or circumstances.

Following the initial purchase, the bundled products and services can be sold in whole or partially consumed form in a suitable secondary market. As previously discussed, a conventional market mechanism such as an auction can be used to set the price of these after market commodities. In addition, product and service providers can impose additional restrictions/mechanisms which can be accommodated in the current invention to restrict transferability in the after-market. With regard to purchasing an option, an expiration date could be specified for the option and an additional payment required to renew the duration of the option.

A method for further specifying and controlling which particular kind of the product and/or service is covered by the bundled commodity or the option on the commodity. For example, for a bulk airline ticket product, each ticket segment of the bundle can be applied towards a flight on the condition that the occupancy of the flight is less than 65%, for example, of total capacity. A condition can then be imposed that, for example, two ticket segments instead of one are required if the occupancy rate requirement is not met. A principal advantage of this aspect of the present invention is the simplification of the current price structure for airline tickets and stabilization of cash flow for the airline employing this method.

In addition, once a commitment is made to use a segment, such as to be on a certain airplane flight, for example, or to rent a particular-size car at a particular location, the ticket segment used to make the commitment can be deemed to be consumed. However, a provider or seller can offer a partial refund or the flexibility of re- commitment for a fee.

In a preferred embodiment of the method of the present invention, the transactions previously discussed are performed on a suitable communication medium such as the Internet. A conventional, searchable inventory of commodities can be generated and provided on a web site for review and selection of the commodities by a consumer. Once the consumer selects his desired commodity and is ready to negotiate, functionality on the web site permits communication with a good/service provider or another consumer seeking to sell a full or partial bulk bundle or an option on a bulk bundle.

Tools which permit the consumer to calculate the value of a given bulk bundle can also be provided. An example of such a valuation tool might be a computer program which calculates price inflation for a group of commodities. For example, if 20 car rentals are purchased in a bulk bundle at 525 per rental day, and if the consumer uses an average of one segment of the car rental bundle per month, then the car rental segment used in the 20th month, for example, will not be subject to any potential interim price increases on the cost of car rental. Another tool which could be made available is one which assists the user in assessing the value of an option. Charts and graphs, for example, showing the historical volatility of the price of the commodity subject to the option could be displayed to assist the potential purchaser in deciding an appropriate option price. It can also be understood that physical access to the Internet can be enabled by a computer connected by wires from a desktop or a mobile device, such as a device sold under the PALM PILOT trade designation. In addition, the practice of the method of the present invention can be effected using wireless protocols to initiate and complete transactions. For example, the negotiation and purchase of a bulk bundled commodity can be completed by communication on the Internet or a similarly suitable, multi-modal connection between or among multiple parties involved in the transaction. It will be appreciated that parties other than the buyer and seller can provide necessary infrastructure services for completing a given transaction, such as by providing payment services.

In addition, a private networking system can be employed, either by itself or in conjunction with an Internet connection, to provide bulk bundles for transfer between or among providers and consumers. In one embodiment, a conventional private networking system such as those operated under the names SABRE, APOLLO and PARS is contemplated for use as a transfer mechanism in the system of the present invention.

A significant advantage offered by the method and system of the present invention is the benefit of price discovery for consumers. The database information stored and used with the present invention provides real time updates on the current market values of given commodities. Particularly with regard to bulk bundled commodities, the likelihood of a volume discount type purchase being available is substantially increased. Therefore, the individual consumer is supplied with additional market knowledge, or price discovery, particularly in an auction scenario where price is subject to free market competition.

A multitude of payment options including, but not limited to, credit card, electronic cash, check, electronic funds transfer (EFT), wire transfer, cash, bank debits and use of credit from the product and/or service vendor or other vendors/providers, can be accommodated by the method and system of the present invention. It can be appreciated, however, that a relatively small number of these payment options including, in particular, credit card, electronic cash and EFT, may account for the most substantial portion of the transactions. It is believed that these payment options provide the greatest efficiency for all parties involved in the practice of the method of the present invention.

The following examples are intended to be illustrative of the method and system of the present invention. It will be understood by one skilled in the art that the scope of the present invention includes goods and services which reflect a multitude of different consumer needs.

### Example 1

An automobile rental company offers a contract to purchase a coupon book which includes 100 coupons for an equivalent number of car rental days at an established price of $25 dollars per day. These car rental coupons can be made redeemable anywhere in the United States or limited to specific geographic regions. In purchasing a bulk bundle of these automobile rental coupons, the consumer can pay the total value of the bulk bundle, which in this example requires a payment of $2500. The consumer can alternatively make a partial payment of $500 with payment terms for the balance of the $2000 price of the bulk bundle, such as by use of a loan or another equivalent credit mechanism.

### Example 2

Alternatively, an option contract associated with a bulk bundle purchase could be provided. For example, for $200 the consumer can be sold the right, but not the obligation, to purchase 100 car rental days at $25 per day at a future time. The purchased option contract can be made fully transferable to any third party or limited to a group of consumers having characteristics similar to the original purchaser. In the present example, these characteristics can include a minimum age requirement (e.g., above 25 years), having a valid credit card and having a valid driver's license. While at least some of the defined characteristics, such as having a valid driver's license, are non-negotiable, other characteristics can be waived on payment of a surcharge added to the original price per day for the car rental.

### Example 3

In a partial consumption embodiment of this example, the seller requires the buyer to use a certain number of the car rental coupons prior to permitting transfer of the remainder of the coupons sold in the bulk bundle. For example, after the purchasing consumer uses 20 of the bulk bundle coupons the remainder (80 coupons) can be sold at the discretion of the consumer. The unconsumed portion of the bulk bundle can be sold in the open market, for example, through an Internet auction/sale site such as one operated under the domain name “ebay.com”.

### Example 4

In another example of the method of the present invention, a consumer arrives at an Internet web site and is presented with a searchable and selectable database of categorized goods and services available for purchase. One item displayed in the database is a bulk bundle of 25 airplane flights being offered by a major airline valid for use in 1999; another item is a bulk bundle of 35 airplane flights which represents the balance on an original bulk bundle of 50 flights and which is offered for sale by an individual consumer; another item is a bulk bundle of 100 razor blades offered by a large company. These items are available either as physical coupons which are mailed to the consumer when purchased, or transferred as electronic credits which can be debited to an account established on the web site for the consumer. Once the desired item is selected, the commodity can be purchased using an auction protocol similar to that established by the functionality of an Internet site of the type operated under the “ebay.com” domain name.

### Additional Examples

Consistent with the automobile rental embodiment, renting a room in a hotel for a night could be another service which is grouped and sold in a bulk bundle. Other possible applications contemplated by the present invention include airplane flights, music in the form of a single song or a collection of songs such as the content of a compact disc (CD). Music bundles can also be sold as a right to download the music from the Internet in a conventional format such as MP3 format, for example. Coupons for staple goods such as reams of printing paper, for example, or other similar office supplies could be grouped into a bulk bundle. The coupons can either be electronically stored or physically produced and sent to the purchaser in a “book” format. It will also be appreciated that relatively large companies can have several branch locations which honor these coupons for redemption to obtain the goods and/or services represented by the coupons.

It will therefore be appreciated that numerous suitable goods and services can be bundled and sold consistent with the method and system of the present invention.

What is claimed is:

1. A computer implemented method for electronic marketing and distribution of commodities and/or options for commodities, said method comprising the steps of:
a) identifying a commodity
b) grouping said commodity in a bundle;
c) storing representative variables of said bundle of commodities in an electronic medium; and
d) performing a transaction with an offer for sale, a bid, and a transfer of said representative variable.

2. The method of claim 1 wherein said transaction step includes the steps of:
a) establishing an initial price for said bundle; and
b) negotiating a final price for said bundle.

3. The method of claim 2 wherein said transaction occurs between a single seller and a single buyer.

4. The method of claim 2 wherein said transaction occurs between multiple buyers and a single seller.

5. The method of claim 4 wherein said initial price is set by said seller.

6. The method of claim 2 wherein said transaction occurs between multiple sellers and a single buyer.

7. The method of claim 6 wherein said initial price is set by said buyer.

8. The method of claim 2 wherein said transaction occurs between multiple buyers and multiple sellers.

9. The method of claim 2 wherein said electronic medium is the Internet.

10. The method of claim 9 further including the step:
a) providing a web site structured to track negotiations on a variety of commodities; and
b) said web site accessible by both buyers and sellers.

11. The method of claim 10 wherein said web site includes tools which calculate the value of a bundle of commodities.

12. The method of claim 11 wherein said web site is structured to accept payment by credit card, electronic cash, or electronic funds transfer.

13. The method of claim 12 further comprising the step of said seller specifying and controlling said commodity in said bundle by placing conditions on the use of said commodity.

14. The method of claim 13 wherein, after said transaction, said buyer transfers said commodity to a third party subject to said conditions.

15. The method of claim 14 further comprising the step of said seller offering a refund to said buyer in exchange for any unused bundle or portion thereof.

16. The method of claim 15 further comprising the step of establishing an option price on said bundle of commodities.

17. The method of claim 16 further comprising the step of said seller specifying a time period in which said option must be exercised.

18. The method of claim 2 further comprising the step of said seller specifying and controlling said commodity in said bundle by placing conditions on the use of said commodity.

19. The method of claim 18 wherein, after said transaction, said buyer transfers said commodity to a third party subject to said conditions.

20. The method of claim 19 further comprising the step of said seller offering a refund to said buyer in exchange for any unused bundle or portion thereof.
